(19) United States
(12) Patent Application Publication
(10) Pub. No.: US 2015/0032582 A1
(43) Pub. Date: Jan. 29, 2015

(54) Signature extraction from accounting ratios

(71) Applicant: Yong Liu, (US)

(72) Inventors: Yong Liu, Ottawa (CA); Christopher Kainan Liu, Ottawa (CA)

(21) Appl. No.: 13/952,692

(22) Filed: Jul. 29, 2013

(51) Int. Cl. G06Q 40/00

(52) U.S. Cl. CPC G06Q 40/12
USPC 705/30

(57) ABSTRACT

The method disclosed includes steps to identify mislabelling based on accounting data. The steps include: extracting a plurality of accounting ratios from accounting data based on a predefined metadata; deriving linguistic values for the accounting ratios; constructing a vector with linguistic values of accounting ratios; comparing the vector with a predetermined signature vector; and reaching a result based on the comparison.

### CROSS-REFERENCE TO RELATED APPLICATIONS

Not applicable.

### REFERENCE TO A COMPUTER PROGRAM LISTING

Computer Program Listing Appendix under Sec. 1.52(e): This application includes a transmittal under 37 C.F.R. Sec. 1.52(e) of a Computer Program Listing Appendix. The Appendix, which comprises text file(s) that are Microsoft Windows Operating System compatible, includes the below-listed file(s). All of the material disclosed in the Computer Program Listing Appendix can be found at the U.S. Patent and Trademark Office archives and is hereby incorporated by reference into the present application.

### BACKGROUND OF THE INVENTION

This disclosure relates generally to the field of processing corporate accounting data contained in balance sheet, income statement, and cash flow, and more particularly to using accounting ratios to identify a mislabelled corporate bond.

Mislabelling is high among investor concerns in a $9 trillion U.S. corporate debt market. Mislabelling involves identifying a non investment-grade security as an investment-grade, or identifying an investment-grade as non investment-grade. Mislabelling in a mortgage market precipitated a financial crisis. Investors need tools to assist them in identifying mislabelling based on public information.

Accounting ratios represent a wealth of information. Depending on the industry, there are about 30-40 line items in a balance sheet, about 20 line items in an income statement, about 20 line items in a cashflow. Taken together, there are about 80 line items to assimilate in each report. However, simple juxtaposition of these 70-80 data items can produce hundreds—thousands of meaningful financial ratios. Including linear combination (addition or subtraction), hundreds—thousands more can be produced. Accounting ratios establish horizontal comparison among peers. Across a peer group, accounting ratios, rather than accounting data itself, are frequently used.

Algorithms developed for mislabelling identification include two main types: some compose a comprehensive score, others perform a database search. The comprehensive score approach works best when a target score is much different from a reference score. In other situations the score is less convincing. A score which rely heavily on sensitive weighting is widely regarded as less credible.

The database search approach is mired in the dilemma between simple and complex search criteria. A simple search may be easily discredited. A complex search where exotic ratios are involved also invites suspicion. In both cases, reliance on sensitive numerical ratios decreases user confidence.

### BRIEF SUMMARY OF THE INVENTION

The present invention provides a computer implemented method with the following characteristics:
(1) mislabelling identification is achieved by matching signature, where signature is extracted from sample data before applied to identification;
(2) conclusion of mislabelling is based on aggregating matching results from multiple channels, corroborative matching increases reliability;
(3) using fuzzy logic to extract a vector from values of accounting ratios.
(4) mislabelling is checked in both sample data and a larger universe of account ratios.

Signature is defined as a representative combination and levels of accounting ratios. Under the disclosed method, a representative vector is extracted from sample data of a well defined group. This vector is used in labelling a target. To augment reliability, matching is conducted at multiple levels. Matching is checked both for sample data collection and larger universe of account ratios. Multiple matches are compared before a final matching conclusion is reached.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is an exemplary representation of a process including signature extraction, signature matching, and conclusion making;

FIG. 2A is an exemplary representation of separate concept maps;

FIG. 2B is an exemplary representation of constructing hierarchy by merging separated maps;

FIG. 3 is an exemplary representation of the relationship between a linguistic variable and an accounting ratio;

FIG. 4 is an exemplary representation of a process of computing a value for a linguistic variable given a base variable;

FIG. 5 is an exemplary representation of an algorithm to extract a characteristics vector;

FIG. 6 is an exemplary representation of an algorithm to extract a core subset vector;

FIG. 7 is an exemplary representation of an iteration to check unintended accounting ratios;

FIG. 8 is an exemplary representation of different types of output from a signature extraction process;

FIG. 9 is an exemplary representation of a matching and conclusion process;

FIG. 10 is an exemplary representation of a computation logic in a multiple channel aggregation.

### DETAILED DESCRIPTION

Successful matching is conditional on successful training Accounting ratio signatures must be acquired during training. Accounting ratio signature includes both composition and levels of accounting ratios. Accounting ratio signature is generated during training. Training involve sample data from a well defined group. Example of such a group would be BBB rated corporations.

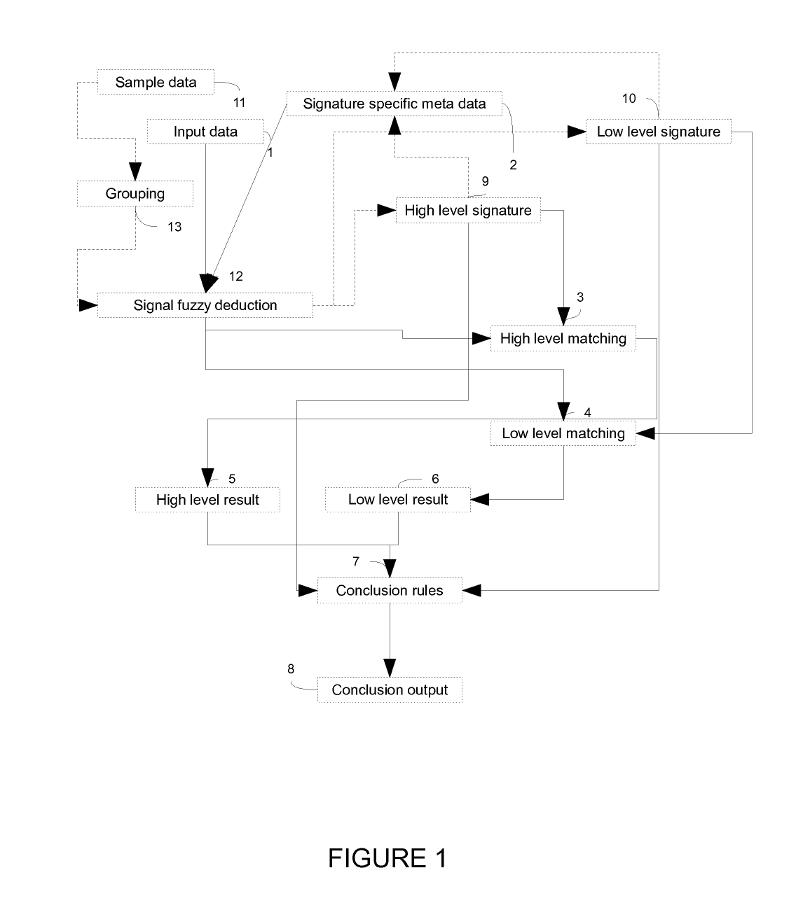

Referring to FIG. 1, an exemplary representation of a process including signature extraction, signature matching, and conclusion making In this process, signatures are extracted from training with sample data. Matching is based on signatures extracted from the training. To distinguish, training related process is denoted with dashed lines. Matching related process is denoted with solid lines.

Training is performed on sample data 11. Three types of output are generated during training Training starts with grouping 13, where high level and low level data are segregated. Metadata 2 defines accounting ratios involved and underlying linguistic variables that group the ratios. Signatures are derived from vectors generated from a fuzzy deduction process 12. Signatures include a high level signature 9 and a low level signature 10. Two signatures are generated for illustration purpose. There is no limit on how may signatures one can generate.

Based on signatures 9, 10, and signature defined metadata 2, matching is ready. Input data 1 is converted to accounting ratios based on the signature defined metadata 2. Base values of accounting ratios are converted to linguistic values through a fuzzy deduction process 12. A vector is generated with linguistic values and matched to high level signature at 3. A feedback is generated based on the matching at 5. A vector is generated and matched to low level signature at 4. A matching result is generated based on the matching at 6. A matching result 5 is combined with result 6 by a conclusion rule at 7. The conclusion is output at 8.

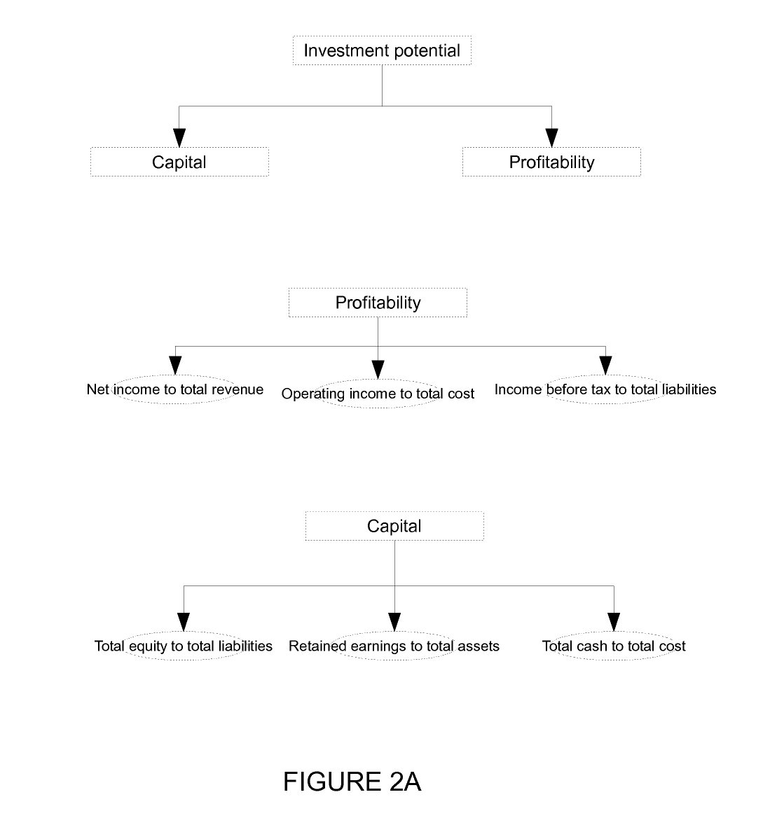

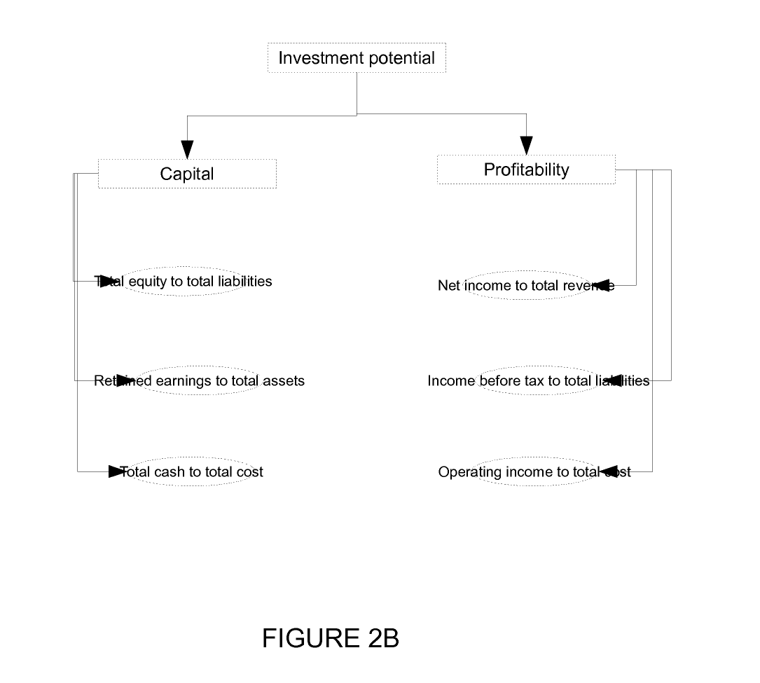

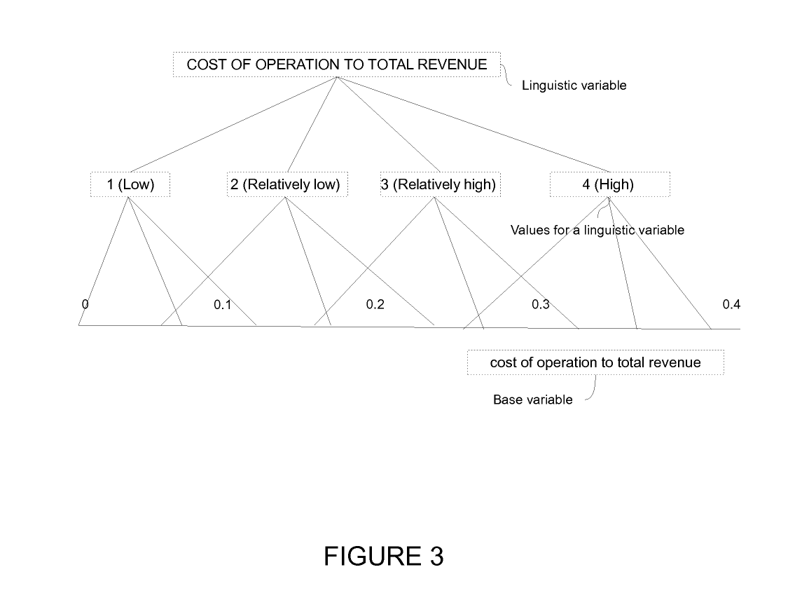

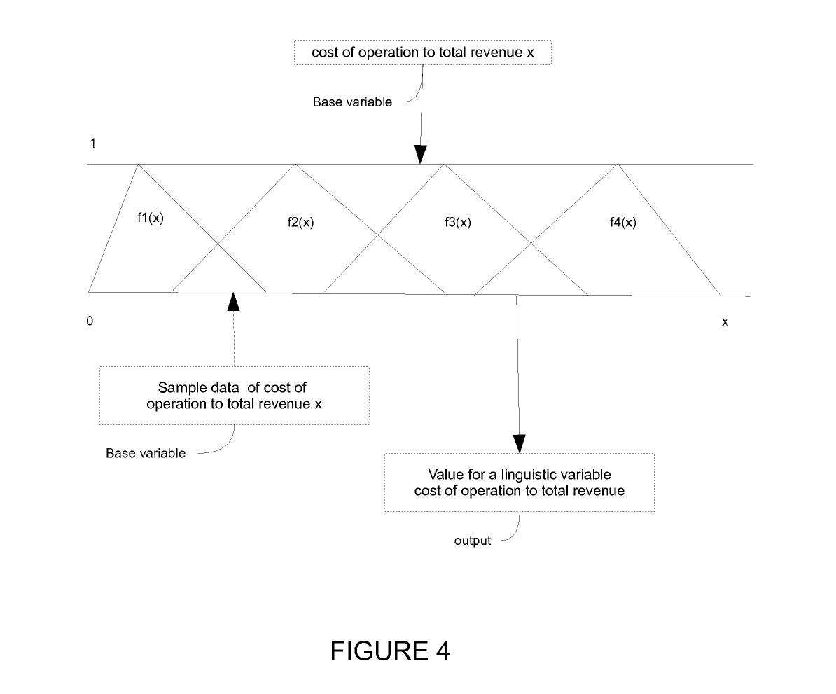

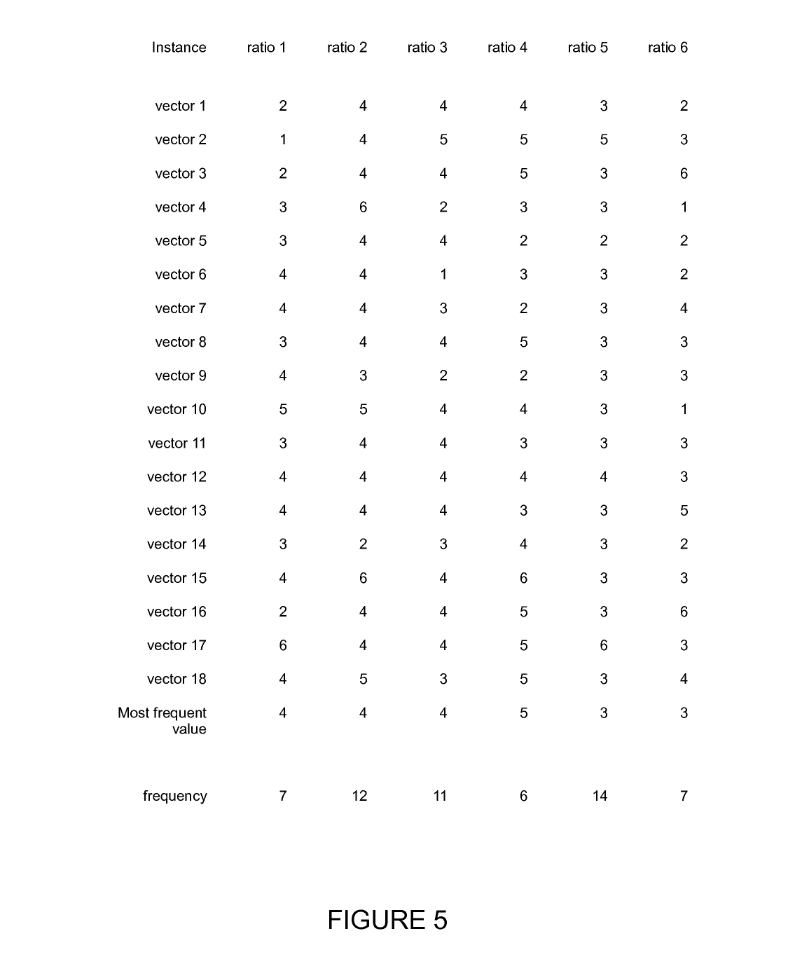

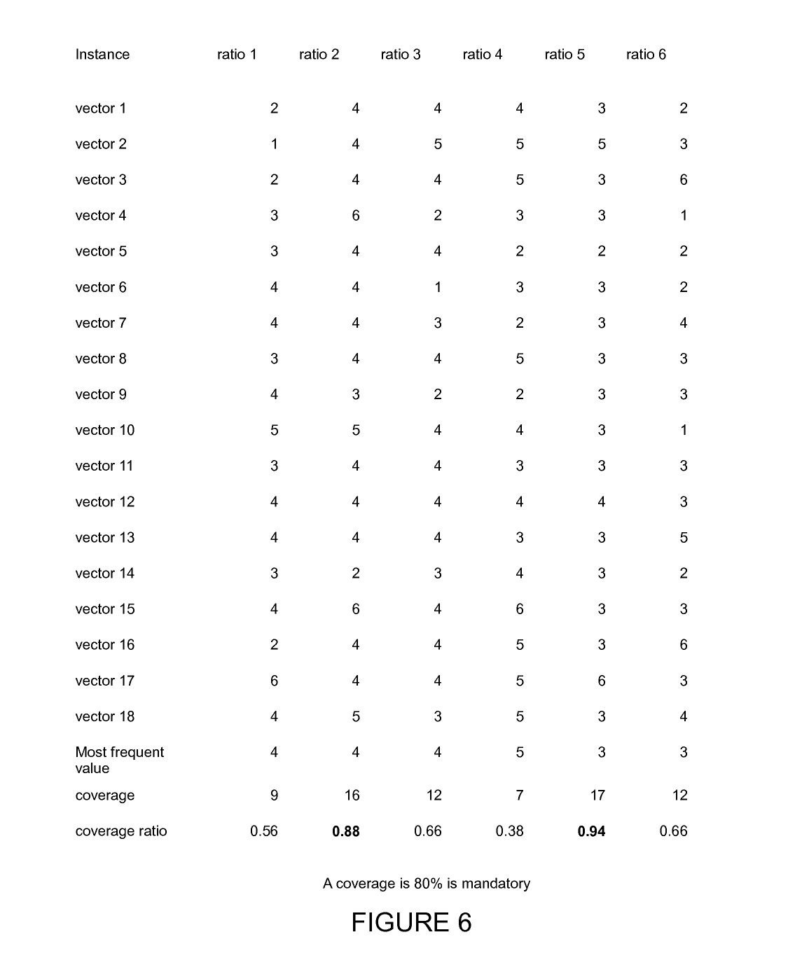

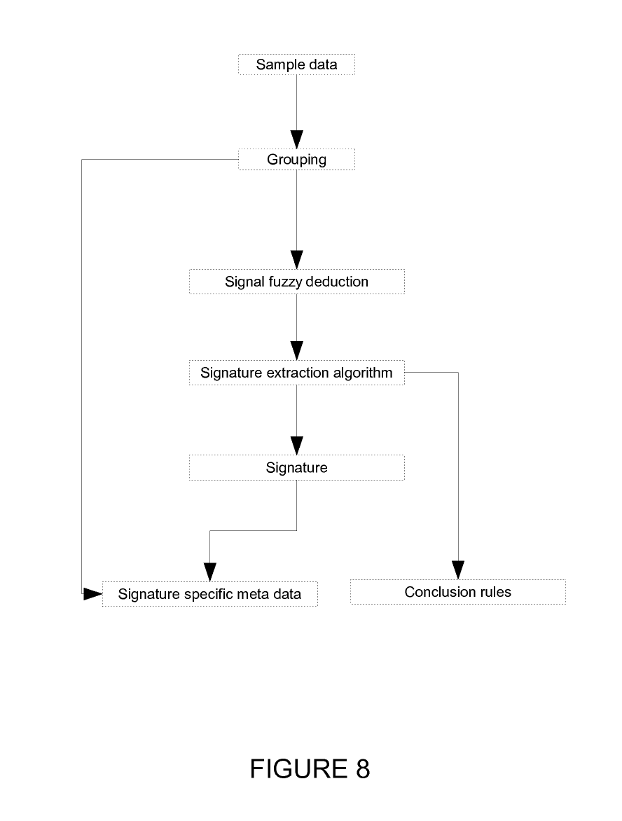

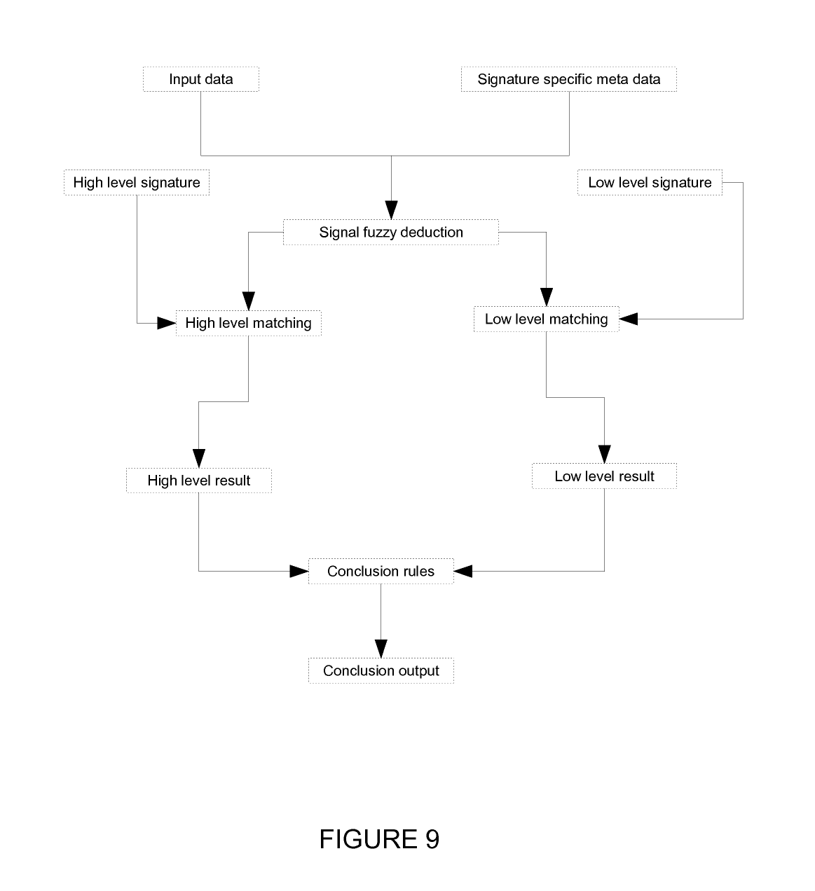

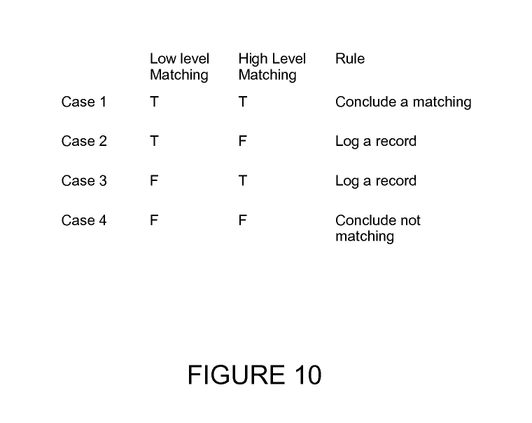

Details of grouping are further explained with FIG. 2A-2B. Details of deriving vector from accounting ratios are further explained in FIG. 3 and FIG. 4. Details of signature extraction algorithms are further explained in FIG. 5 and FIG. 6. Training process is further explained in FIG. 8. Matching process is further explained in FIG. 9. Conclusion rule process is further illustrated in FIG. 10.

Reliability of the disclosed method relies on results from different channels such as high level matching and low level matching. The hierarchy is generated from grouping. In practise, rating or other investment decisions are made based on abstract concepts, not an accounting ratios. Example of an abstract concept is investment potential. Substantiating an abstract concept with accounting ratios is accomplished with concept maps.

Referring to FIG. 2A, a representation of separated concept maps. Concept seldom exists in isolation. Sometimes an abstract concept is represented by a plurality of relative concrete concepts. In other times a concept is represented by a plurality of accounting ratios. In FIG. 2A, three concept maps exist in separate contexts. In FIG. 2A, a concept investment potential is substantiated with two other concepts: capital and profitability. The concept of profitability is related with three accounting ratios: net income to total revenue; operating income to total cost; and income before tax to total liabilities. The concept of capital is related to three accounting ratios: total equity to total liabilities; retained earnings to total assets; and total cash to total cost. These concept maps are left unconnected.

Referring to FIG. 2B, a representation of constructing hierarchy by merging separated maps. A hierarchy is formed as a result of merging common elements. In the hierarchy, investment potential is a high level representation, profitability and capital are also high level representation, accounting ratios are low level representation. A low level representation is defined as one comprising of accounting ratios. Note that every time a plurality of accounting ratios are grouped together, the underlying concept that groups the ratios together can always be regarded as a high level representation. When there are more than one high level concepts at the same level, a high level vector can be formed based on the values of linguistic variables. If there is only one concept at high level, a high level scalar can be achieved. A representative implementation of a tool to bind a plurality of concepts to a concept, and to bind a plurality of accounting ratios to a concept is included in the program listing. The purpose of the hierarchy is segregation of vector derived from accounting ratio and vector derived from grouping concepts.

Vector plays an important role in the disclosed method. Signature in the disclosed method refers specifically to a signature vector. In general, a real vector is an array of real numbers [a1, a2, . . . , an]. Here, the real numbers are values of linguistic variables. Defined by professor Zadeh, a linguistic variable is a plurality of concept describing words or sentences with value. The objective here is to derive a vector based on accounting ratios. The value of an accounting ratio and a linguistic variable is related. Referring to FIG. 3, an exemplary representation of the relationship between a linguistic variable and an accounting ratio. In FIG. 3, the same accounting ratio (cost of operation to total revenue) is shown in both upper case and lower case. The one in lower case is the base value. It carries a numerical value derived by dividing one accounting data with another. The one in upper case is a linguistic variable for the same ratio. The values for the linguistic variable in the example is low (1), relatively low (2), relatively high (3), and high (4). For purpose of signature extraction, values for the linguistic variable is preferred.

Applying fuzzy logic to derive a linguistic variable follows standard fuzzy logic steps: (1) deriving membership functions; (2) evaluating an input base variable against all membership functions; (3) and applying a Zadeh operator to get a value for a linguistic variable. The Zadeh operator is well known in fuzzy logic. Referring to FIG. 4, an exemplary representation of a process of computing a value for a linguistic variable given a base variable. In FIG. 4, the dashed line indicates that a plurality of sample data is employed in deriving membership functions before they are used to compute a linguistic variable. The membership functions in the figure are trapezoidal. A trapezoidal membership functions consist of a plurality of linear functions. Membership functions can also be non linear. A representative implementation of both trapezoidal membership function and a non linear membership function based on sample accounting ratios is included in the submitted program listing. A fuzzy input in the form of an accounting ratio is evaluated based on membership functions f1(x), . . . f4(x). A Zadeh OR operator is applied. The Zadeh OR is implemented as a maximum function. If max==f1 (x), then the value for the linguistic variable is 1. If max==f2(x), then the value for the linguistic variable is 2, and so on. Value for a linguistic variable is computed as a result.

For an array of N different accounting ratios, N linguistic values will be computed. A vector can be formed with these values: [v1, v2, . . . , vn]. A vector formed with linguistic values for accounting ratios is a low level vector. Sample data of low level vectors are used to extract signature of a well defined group. Metadata is also generated based on a low level vector.

A high level vector is generated with linguistic values of high level concepts. Logical grouping exists everywhere. In a daily working environment, most analysts think of logical concepts before going to details of accounting ratio. For example, the federal government applies a Uniform Financial Institutions Rating System (UFIRS) on regulated banks Bank rating is classified by six factor components including adequacy of capital; the quality of assets; the capability of management; the quality and level of earnings; the adequacy of liquidity; and the sensitivity to market risk. These factor components can be used to logically group accounting ratios. Accounting ratios such as total equity to total liabilities, retained earnings to total assets, and total cash to total liabilities can then be grouped under adequacy of capital. Similarly, other factor components can be used to group a plurality of accounting ratios.

These high level concepts are themselves linguistic variables. Their values are derived from underlying accounting ratios. A Zadeh operator is applied to compute the value for a high level linguistic variable given linguistic values of underlying accounting ratios. For a logical OR operation, the implementation is maximum. For a logical AND operation, the implementation is minimum. As a result, there can be a number of possibilities for a high level linguistic value. Specific type of logical operation is determined based on the context of the grouping and the high level concept involved. For an array of m high level concepts, a vector of [v1, v2, . . . vm] can be computed in this manner. For a single high level concept, a scalar is resulted instead.

Based on vectors generated, it is possible to extract signatures based on group of sample data. A group of sample data forms a matrix. A signature is extracted from the matrix based on an algorithm. This can be performed separately both for high level vectors and low level vectors. Two extraction algorithms are disclosed. One is the characteristics vector algorithm, the other is the core subset vector algorithm.

A characteristics vector is defined as a vector which consists of most frequent values of a column in a sample data matrix. This algorithm works best when combination of accounting ratios is specified. Referring to FIG. 5, an exemplary representation of an algorithm to extract a characteristics vector. The sample data matrix consists of 18 vectors. Each vector is defined by 6 linguistic values corresponding to ratio 1 to ratio 6. The frequency for each element in a column is counted. The most frequent value is determined by largest count. The most frequent value for ratio 1 is 4. It appears 7 times. The most frequent value for ratio 2 is 4. It appears 12 times. The most frequent value for ratio 3 is 4. It appears 11 times. The most frequent value for ratio 4 is 5. It appears 6 times. The most frequent value for ratio 5 is 3. It appears 14 times. The most frequent value for ratio 6 is 3. It appears 7 times.

The characteristics vector extracted therefore is [4,4,4,5,3,3]. The characteristic vector actually is the signature vector. It means the group represented by the sample data is defined by a value of 4 and up for ratio 1, and a value of 4 and up for ratio 2, and a value of 4 and up for ratio 3, and a value of 5 and up for ratio 4, and a value of 3 and up for ratio 5, and a value of 3 and up for ratio 6. Based on the signature vector, the vector [5,4,5,5, 4,3] belongs to the group. The vector [3, 4, 6, 4, 3, 3] does not belong to the group. Both [5,4,5,5, 4,3] and [3, 4, 6, 4, 3, 3] are not in the sample data. In case of a scalar, only one number is extracted. A representative implementation is included in the program listing.

Sample data failing to meet the characteristics vector can be identified by scanning the matrix. Vector 1, vector 2, vector 3, vector 4, vector 5, vector 8, vector 11, vector 14 and vector 16 do not meet the criteria set forth by the signature vector. Identification of these vectors help in identifying mislabelling: these do not meet a common standard even though they are in the group. A matrix formed by these vectors can be sorted by an important ratio and presented to the conclusion rule identified in FIG. 1. This is identified in FIG. 1. by the curved arrow between high level signature 9 and conclusion rule 7, and by the curved arrow between low level signature 10 and conclusion rule 7.

The characteristics vector algorithm works best when the combination of accounting ratios is pre-determined. In many cases, the right mix of ratios are not known. The core subset vector algorithm works best under this circumstance. Referring to FIG. 6, an exemplary representation of an algorithm to extract a core subset vector. This algorithm computes most frequent element for each column. It also computes coverage in terms of frequency. And there is a mandatory coverage ratio associated with the frequency. This ratio is 80% in the example in FIG. 6. A linguistic value 4 covers 88% of ratio 2 in the sample data, therefore it can be inferred that most member in the group share this gene. A linguistic value 3 covers 94% of ratio 5 in the sample data, it is be inferred that this is also a genetic information. Ratio 2 and ratio 5 form a core subset of ratios. The signature is contained in the subset. And matching at later stage will be conducted only on the subset. Determination of the subset is based on a frequency parameter related to a linguistic value of accounting ratios involved.

In practise, a much larger set of accounting ratios can be involved in a the process illustrated in FIG. 6. Mislabelling identification includes singling out unintended attributes. In a mortgage backed security example, non investment factors were included in a AAA group unintentionally. The disclosed algorithm is intended to help in uncovering unintended ratios for corporate bonds.

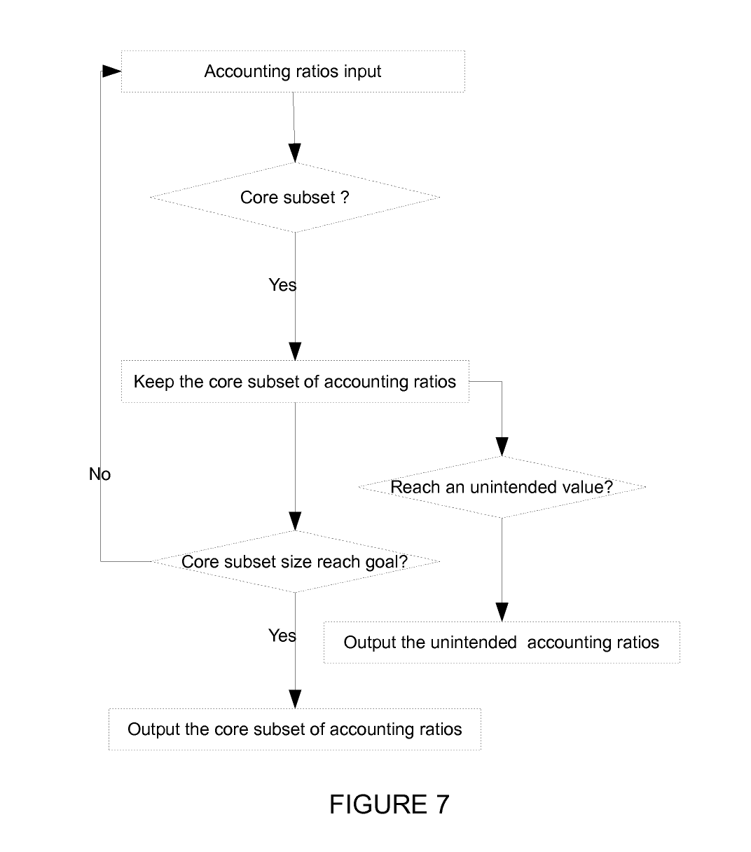

Referring to FIG. 7, an exemplary representation of an iteration to check unintended accounting ratios. In every step of the iteration, a new accounting ratio is added to the loop. Three checks are performed: (1) checking whether this accounting ratio belong to the core subset; (2) checking if the predetermined size of the core set has been reached; (3) and checking weather linguistic value for the ratio reached the unintended level. The output includes two collections: one is the collection for the core subset; the other is a collection of unintended account ratios. The result of unintended accounting ratio list is also fed into conclusion rules in FIG. 1. In this process, sample data is segregated from the rest based on an operation involving a value of a signature vector.

As a result of extracting signature from sample data, three types of output are generated. Referring to FIG. 8, an exemplary representation of different types of output from a signature extraction process. In FIG. 8, sample data of accounting ratios are input to a fuzzy logic process to generate linguistic values. A characteristics vector algorithm or a core subset algorithm is applied to linguistic values to generate signature. Signature is type 1 output. Signature specific metadata is generated based on signature. For the characteristics vector algorithm, the signature specific metadata includes the complete set of accounting ratios provisioned in the sample data. For the core subset algorithm, the signature specific metadata includes only accounting ratios in the core subset. Signature specific metadata is type 2 output. A candidate matrix of mislabelled sample data is produced by the characteristics vector algorithm, a unintended list of accounting ratios are produced by the core subset algorithm. These are type 3 output. Type 3 output is forwarded to the conclusion rules object outlined in FIG. 1. As indicated in FIG. 1, this process is conducted independently for both high level signature and low level signature.

Three types of input are needed during matching. Referring to FIG. 9, an exemplary representation of a matching and conclusion process. Type 1 input is input of accounting ratios. Type 2 input is a signature. Type 3 input is signature specific metadata. Based on the metadata and accounting ratios, fuzzy deduction is performed to extract a vector comprising of linguistic values. A matching result is generated by comparing the vector against the signature. Matching follows an equal or larger rule. If the signature vector is [3,4,5,6,7,8], a vector with value of [3,4,5,6,7,8] is an obvious match. More importantly, vectors with value of [4,4,5,6,7,8] and [5,5,5,7,7,8] are also match because their values are greater than the corresponding values in the signature vector. The matching result is forwarded to a conclusion rules object.

This process is executed in a parallel manner for both high level signatures and low level signatures. The purpose of the conclusion rules object is to aggregate based on potentially conflicting results. Referring to FIG. 10, an exemplary representation of a computation logic in a multiple channel aggregation. There are four possible cases for a two channel matching: matching is found both at high level and low level; matching is found at high level but not at low level; matching is found at low level but not at high level; and matching is not found at both high level and low level. A conclusion rules object can execute logical OR or logical AND. FIG. 10 illustrates logical AND. Matching is concluded only if matching is found at both channels. A log record is created if one is found at least on matching is found. Essentially, logging is governed by a logical OR operator. In case where some vectors belonging to the target group are not caught in this process, rules can be amended by checking at log records. When both high level result and low level result indicate not matching, then the conclusion is not matching.

In conclusion, a method to identify mislabelling is disclosed. The identification process rely on accounting ratios. A vector is constructed by performing fuzzy deduction on accounting ratios. A vector which contain common elements of a well defined group is extracted as a signature for the group. Sample data is grouped into high level and low level representation. Signatures are extracted for both representations. Sample data in contradiction to the signatures are extracted as candidates for mislabelling. Sample data matching signatures are also checked for unintended values. Signatures extracted are used in matching both in the sample data and in a larger accounting ratio universe. Matching reached at intra-channel level is forwarded to a conclusion rule object to perform inter channel logical decision. Reliability is enhanced both by vector level signature matching and multiple channel corroboration.

What is claimed:

1. A method comprising: extracting a plurality of accounting ratios from accounting data based on a predefined metadata; deriving linguistic values for the accounting ratios; constructing a vector with linguistic values of accounting ratios; comparing the vector with a predetermined signature vector; and reaching a result based on the comparison.

2. A method according to claim 1, where the predetermined signature vector is extracted from a plurality of sample data from a well defined group, the combination of accounting ratios is specified.

3. A method according to claim 1, where the predetermined signature vector is extracted from a plurality of sample data from a well defined group, a frequency parameter related to a linguistic value of accounting ratio is specified.

4. A method according to claim 1, where at least one linguistic variable is involved in grouping accounting ratios, Linguistic variables for accounting ratios and linguistic variables for the grouping are segregated accordingly.

5. A method according to claim 4, where signature vectors are extracted according to the segregation.

6. A method according to claim 4, where metadata is determined by a signature vector and the corresponding segregation.

7. A method according to claim 6, where a plurality of accounting ratios are grouped by at least one linguistic variable, comprising: deriving linguistic values for the accounting ratios based on a predefined metadata; deriving linguistic values for the grouping linguistic variables based on linguistic values of accounting ratios; constructing vectors separately for accounting ratios and grouping linguistic variables; matching with signature vectors separately; converging matching results together; and performing a logical operation to determine a final result.

8. A method according to claim 2, where at least one sample data is segregated from the rest based on an operation involving a signature vector;

9. A method according to claim 3, where at least one sample data is segregated from the rest based on an operation involving a value of a signature vector;

10. A method according to claim 1, where linguistic variable is derived, the membership functions are non linear.

11. A method according to claim 1, where linguistic variable is derived, the membership functions are trapezoidal.
